(19) United States
(12) Patent Application Publication
(10) Pub. No.: US 2026/0292472 A1
(43) Pub. Date: Sep. 24, 2026

(54) Inter-PLMN Subscription Management in Standalone Non-Public Networks

(71) Applicant: Telefonaktiebolaget LM Ericsson (publ), Stockholm (SE)

(72) Inventors: Jesús Ángel De Gregorio Rodriguez, Boadilla del Monte, Madrid (ES); Emiliano Merino Vazquez, Madrid (ES)

(21) Appl. No.: 19/168,487

(22) PCT Filed: Apr. 4, 2024
(86) PCT No.: PCT/EP2024/059187

§ 371 Date: Sep. 24, 2025

(30) Foreign Application Priority Data
Apr. 5, 2023 (EP) 23382329.3

(51) Int. Cl. H04W 8/20; H04W 4/60; H04W 8/26; H04W 88/06

(52) U.S. Cl. CPC H04W 8/20; H04W 4/60; H04W 8/26; H04W 88/06

(57) ABSTRACT

This disclosure provides a method for managing inter-PLMN subscriptions towards a Network Repository Function of a Standalone Non-Public Network in a communications network. The method comprises receiving at a first network node from a network function consumer a subscription request; transmitting from the first network node to a second network node the subscription request; creating at the second network node a subscription identifier that includes a Mobile Country Code (MCC), a Mobile Network Code (MNC), and a Network Identifier (NID) of the Standalone Non-Public Network, SNPN; transmitting from the second network node to the first network node the subscription identifier; and providing from the first network node to the network function consumer the subscription identifier.

### TECHNICAL FIELD

The present invention relates generally to communication networks, and more specifically, to a system and method for managing inter-Public Land Mobile Network (PLMN) subscriptions in Standalone Non-Public Networks (SNPNs).

### BACKGROUND

Non-public networks (NPNs) are networks designed for non-public use, which can be deployed in various configurations, utilizing both virtual and physical network elements. The concept of a private network is encompassed within NPNs, referring to isolated network deployments that do not interact with public networks. Among the many possible configurations of NPNs, 3GPP identifies two primary categories: Standalone Non-Public Networks (SNPNs) and Public network integrated NPNs (PNI-NPNs).

SNPNs represent a type of NPN that does not depend on network functions provided by a Public Land Mobile Network (PLMN) or, in simpler terms, a mobile network operator. When an SNPN is deployed in isolation, it corresponds to the concept of a private network. This implies that SNPNs require a higher level of investment and commitment from the network operator.

In this context, Network Function (NF) service consumers discover NF service producers based on the SNPN-ID, which is composed of the PLMN-ID and the Network Identifier (NID) (PLMN-ID+NID). However, the management of subscriptions and the interaction between SNPNs and PLMNs remain challenging due to the variety of configurations and evolving network technologies.

The current approach for managing subscriptions in Standalone Non-Public Network (SNPN) scenarios presents several issues. When a Network Function (NF) service consumer in a visited network subscribes to the Home PLMN Network Repository Function (NRF), it contacts the local NRF in the visited PLMN. The local Network Repository Function (NRF) then needs to contact the Home PLMN NRF, which may route the request to the final NRF hosting the NF service producer.

In these scenarios, an NF Consumer in a visited PLMN may create a subscription on the home NRF (i.e., the NRF in the SNPN) to receive notifications about profile changes for sets of NF instances. This subscription is created via the local NRF in the visited PLMN. The home NRF generates a subscription ID containing routing information, such as the identity of the SNPN, and sends it through the local NRF to the NF Consumer in the Visited PLMN.

The NF Consumer can further interact with the newly created subscription (e.g., to modify or terminate it) based on the Subscription ID by sending HTTP requests to the resource: . . . /subscriptions/{subscriptionID}. Including routing information in the subscription ID allows the local NRF in the visited PLMN not to maintain state for each created subscription in different home PLMNs, which would be unmanageable.

A problematic aspect of the current definition of the subscription ID, which is as follows: <MCC>+<MNC>+“−”+<OriginalSubscriptionID> (Regex Pattern: \hat{ }([0-9]{5,6}−)?[\hat{ }−]+$), is that it does not allow to route the request to the appropriate NRF in the SNPN-ID properly. As a result, managing inter-PLMN subscriptions towards the NRF of an SNPN is not feasible with the current subscription ID definition. There is a need for a more effective method to manage subscriptions in SNPN scenarios, ensuring proper routing and communication between NRFs, NF service consumers, and NF service producers.

### SUMMARY

The invention is set out in the appended set of claims.

The object of the invention is to provide an efficient and reliable method for managing inter-PLMN subscriptions towards a Network Repository Function (NRF) of a Standalone Non-Public Network (SNPN) in a communications network. The proposed solution aims to overcome the limitations of the current subscription ID definition, by including the Network Identifier (NID) of the SNPN, and thus, allowing proper routing of requests to the appropriate NRF in the SNPN-ID.

An aspect of the invention relates to a method performed by a first network node for managing inter-PLMN subscriptions towards a Network Repository Function of a Standalone Non-Public Network in a communications network. The method comprises receiving at a first network node from a network function consumer a subscription request; transmitting from the first network node to a second network node the subscription request; receiving at the first network node from the second network node a subscription identifier that includes a Mobile Country Code (MCC), a Mobile Network Code (MNC), and a Network Identifier (NID) of the Standalone Non-Public Network, SNPN; and providing from the first network node to the network function consumer the subscription identifier. In some embodiments, the subscription identifier is generated in the following format:
<MCC>+<MNC>+““−”” ““+””:nid=<NID>:””+<OriginalSubscriptionID>. In some embodiments, the subscription identifier further includes a magic cookie to maintain compatibility with earlier API versions. In some embodiments, the subscription identifier includes the NID of the SNPN preceded by the magic cookie. In some embodiments, the magic cookie is ““x3Lf57A””. In some embodiments, the subscription identifier is generated in the following format:
<MCC>><MNC>+““−””+<magic_cookie>+““:nid=<NID>:””+><OriginalSubscriptionID>. In some embodiments, the NF service consumer in the visited PLMN uses the subscription identifier to modify or terminate the subscription. In some embodiments, the local NRF in the visited PLMN does not maintain a state for each created subscription in different home PLMNs. In some embodiments, the local NRF routes the subscription request towards the SNPN NRF based on the MCC, the MNC and the NID. In some embodiments, the first network node is a local Network Repository Function in a visited Public Land Mobile Network, the second network node is a home Network Repository Function in a Home Public Land Mobile Network, and the network function consumer is a Network Function service consumer in the visited Public Land Mobile Network.

A further aspect of the invention relates to a method performed by a second network node for managing inter-PLMN subscriptions towards a Network Repository Function of a Standalone Non-Public Network in a communications network. The method comprises receiving at a second network node from a first network node a subscription request; creating at the second network node a subscription identifier that includes a Mobile Country Code (MCC), a Mobile Network Code (MNC), and a Network Identifier (NID) of the Standalone Non-Public Network, SNPN; and transmitting from the second network node to the first network node the subscription identifier. In some embodiments, the subscription identifier is generated in the following format:
<MCC>+<MNC>+““−””+““+””:nid=<NID>:””+<OriginalSubscriptionID>. In some embodiments, the subscription identifier further includes a magic cookie to maintain compatibility with earlier API versions. In some embodiments, the subscription identifier includes the NID of the SNPN preceded by the magic cookie. In some embodiments, the magic cookie is ““x3Lf57A””. In some embodiments, the subscription identifier is generated in the following format:
<MCC>+<MNC>+““−””+<magic_cookie>+““:nid=<NID>:””+<OriginalSubscriptionID>. In some embodiments, the NF service consumer in the visited PLMN uses the subscription identifier to modify or terminate the subscription. In some embodiments, the local NRF in the visited PLMN does not maintain a state for each created subscription in different home PLMNs. In some embodiments, the local NRF routes the subscription request towards the SNPN NRF based on the MCC, the MNC and the NID. In some embodiments, the first network node is a local Network Repository Function in a visited Public Land Mobile Network, the second network node is a home Network Repository Function in a Home Public Land Mobile Network, and the network function consumer is a Network Function service consumer in the visited Public Land Mobile Network.

A further aspect of the invention relates to a method performed by a network function consumer for managing subscriptions towards a second network node of a Standalone Non-Public Network in a communications network, SNPN, the method performed by a network function consumer, the method comprising transmitting to a first network node a subscription request; receiving from the first network node a subscription identifier; wherein the subscription identifier includes a Mobile Country Code, MCC, a Mobile Network Code, MNC, and a Network Identifier, NID, of the SNPN.

Other aspects of the invention relate to mobile network nodes, particularly a first network node (110, 500), a network function consumer (700), and a second network node (110, 600) configured to perform the respective methods as described herein. Other aspects of the invention relate to computer program and computer program products.

In some embodiments, the first network node is a local NRF in a visited Public Land Mobile Network (local NRF). In some embodiments, the network function consumer is a Network Function service consumer in the visited PLMN (NFc). In some embodiments, the second network node is a home NRF in a Home Public Land Mobile Network (home NRF).

Advantageously, the proposed solution enables improved routing and communication by incorporating the Network Identifier (NID) of the Standalone Non-Public Network (SNPN) into the subscription ID. The proposed solution facilitates proper routing and communication between Network Repository Functions (NRFs), Network Function (NF) service consumers, and NF service producers. This results in more efficient and reliable management of inter-PLMN subscriptions in SNPN scenarios.

Further advantageously, the proposed solution eliminates the need for local NRFs in the visited Public Land Mobile Network (PLMN) to maintain state for each created subscription in different home PLMNs. This reduces the complexity and overhead associated with managing inter-PLMN subscriptions, leading to a more scalable and manageable system.

Further advantageously, the proposed solution accommodates backward compatibility with earlier API versions through the inclusion of a magic cookie in the subscription ID. This enables seamless interaction between different versions of APIs, improving the overall interoperability of the system.

Further advantageously, the proposed solution allows NF service consumers in the visited PLMN to interact with the subscription identifier to modify or terminate subscriptions. This provides them with greater control and flexibility in managing their subscriptions, ultimately enhancing the user experience.

Further advantageously, the proposed solution is applicable to a wide range of non-public network configurations, including both Standalone Non-Public Networks (SNPN) and Public network integrated Non-Public Networks (PNI-NPN). This broad applicability ensures that the invention can be effectively utilized in various networking environments.

Further advantageously, the proposed solution enables better isolation of non-public networks from public networks by incorporating the SNPN-ID into the subscription ID, reducing potential security risks and ensuring a higher level of privacy for users operating within the non-public network environment.

Additional objectives, features and advantages of the concepts disclosed herein will be apparent from the following description, claims and drawings, or may be learned by practice of the described technologies and concepts as set forth herein.

### BRIEF DESCRIPTION OF THE DRAWINGS

In order to best describe the manner in which the disclosed concepts may be implemented, as well as define other objects, advantages and features of the disclosure, a more particular description is provided below and is illustrated in the appended drawings. Understanding that these drawings depict only exemplary embodiments of the invention and are not therefore to be considered to be limiting in scope, the examples will be described and explained with additional specificity and detail through the use of the accompanying drawings.

FIG. 1 illustrates an example networked system in accordance with particular embodiments of the solution described herein.

FIGS. 2A, 2B and 2C illustrate example signaling diagrams showing a procedure according to particular embodiments of the solution described herein.

FIG. 3A illustrates an example flowchart showing a method performed by a mobile network node according to particular embodiments of the solution described herein.

FIG. 3B illustrates an example flowchart showing a method performed by a mobile network node according to particular embodiments of the solution described herein.

FIG. 4 illustrates an example flowchart showing a method performed by a mobile network node according to particular embodiments of the solution described herein.

FIG. 5 illustrates an example block diagram of a mobile network node configured in accordance with particular embodiments of the solution described herein.

FIG. 6 illustrates an example block diagram of a mobile network node configured in accordance with particular embodiments of the solution described herein.

FIG. 7 illustrates an example block diagram of a mobile network node configured in accordance with particular embodiments of the solution described herein.

FIG. 8 illustrates an example block diagram of a virtualized environment.

### DETAILED DESCRIPTION

The invention will now be described in detail hereinafter with reference to the accompanying drawings, in which examples of embodiments or implementations of the invention are shown. The invention may, however, be embodied or implemented in many different forms and should not be construed as limited to the embodiments set forth herein. Rather, these embodiments are provided so that this disclosure will be thorough and complete, and will fully convey the scope of present invention to those skilled in the art. It should also be noted that these embodiments are not mutually exclusive. Components from one embodiment may be tacitly assumed to be present/used in another embodiment. These embodiments of the disclosed subject matter are presented as teaching examples and are not to be construed as limiting the scope of the disclosed subject matter. For example, certain details of the described embodiments may be modified, omitted, or expanded upon without departing from the scope of the described subject matter.

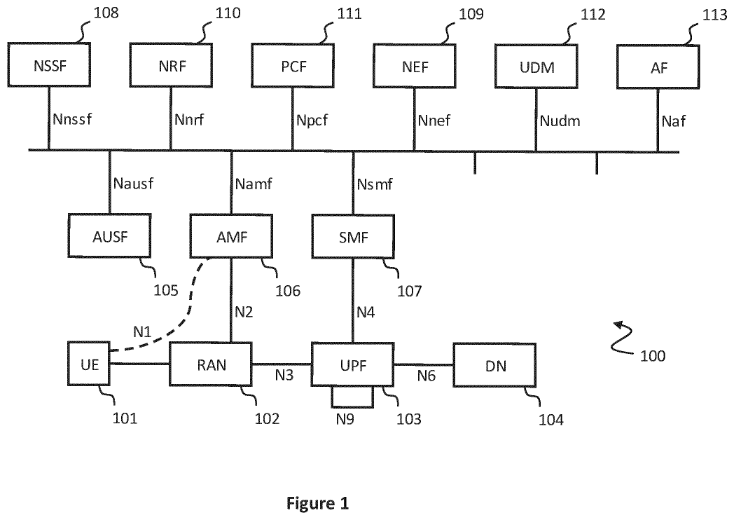

The example embodiments described herein arise in the context of a telecommunications network, including but not limited to a telecommunications network that conforms to and/or otherwise incorporates aspects of a fifth generation (5G) architecture. FIG. 1 is an example networked system 100 in accordance with example embodiments of the present disclosure. FIG. 1 specifically illustrates User Equipment (UE) 101, which may be in communication with a (Radio) Access Network (RAN) 102 and Access and Mobility Management Function (AMF) 106 and User Plane Function (UPF) 103. The AMF 106 may, in turn, be in communication with core network services including Session Management Function (SMF) 107 and Policy Control Function (PCF) 111. The core network services may also be in communication with an Application Server/Application Function (AS/AF) 113. Other networked services also include Network Slice Selection Function (NSSF) 108, Authentication Server Function (AUSF) 105, User Data Management (UDM) 112, Network Exposure Function (NEF) 109, Network Repository Function (NRF) 110 and Data Network (DN) 104. In some example implementations of embodiments of the present disclosure, each one of the entities in the networked system 100 are considered to be a Network Function (NF). One or more additional instances of the NFs may be incorporated into the networked system.

The solution described herein aims to provide an efficient and reliable method for managing inter-PLMN subscriptions towards a Network Repository Function (NRF) of a Standalone Non-Public Network (SNPN) in a communications network. The proposed solution aims to overcome the limitations of the current subscription ID definition, by including the Network Identifier (NID) of the SNPN, and thus, allowing proper routing of requests to the appropriate NRF in the SNPN-ID.

This disclosure provides a method for managing inter-PLMN subscriptions towards a Network Repository Function of a Standalone Non-Public Network in a communications network. The method comprises receiving at a first network node from a network function consumer a subscription request; transmitting from the first network node to a second network node the subscription request; creating at the second network node a subscription identifier that includes a Mobile Country Code (MCC), a Mobile Network Code (MNC), and a Network Identifier (NID) of the Standalone Non-Public Network, SNPN; transmitting from the second network node to the first network node the subscription identifier; and providing from the first network node to the network function consumer the subscription identifier. In some embodiments, the subscription identifier is generated in the following format:
<MCC>+<MNC>+““−” “+””:nid=<NID>:””+<OriginalSubscriptionID>. In some embodiments, the subscription identifier further includes a magic cookie to maintain compatibility with earlier API versions. In some embodiments, the subscription identifier includes the NID of the SNPN preceded by the magic cookie. In some embodiments, the magic cookie is “x3Lf57A”. In some embodiments, the subscription identifier is generated in the following format:
<MCC>+<MNC>+““−””+<magic_cookie>+““:nid=<NID>:””+<OriginalSubscriptionID>. In some embodiments, the NF service consumer in the visited PLMN uses the subscription identifier to modify or terminate the subscription. In some embodiments, the local NRF in the visited PLMN does not maintain a state for each created subscription in different home PLMNs. In some embodiments, the local NRF routes the subscription request towards the SNPN NRF based on the MCC, the MNC and the NID. In some embodiments, the first network node is a local Network Repository Function in a visited Public Land Mobile Network, the second network node is a home Network Repository Function in a Home Public Land Mobile Network, and the network function consumer is a Network Function service consumer in the visited Public Land Mobile Network.

An aspect of the invention relates to a method performed by a first network node for managing inter-PLMN subscriptions towards a Network Repository Function of a Standalone Non-Public Network in a communications network. The method comprises receiving at a first network node from a network function consumer a subscription request; transmitting from the first network node to a second network node the subscription request; receiving at the first network node from the second network node a subscription identifier that includes a Mobile Country Code (MCC), a Mobile Network Code (MNC), and a Network Identifier (NID) of the Standalone Non-Public Network, SNPN; and providing from the first network node to the network function consumer the subscription identifier. In some embodiments, the subscription identifier is generated in the following format:
<MCC>+<MNC>+““−” “+””:nid=<NID>:””+<OriginalSubscriptionID>. In some embodiments, the subscription identifier further includes a magic cookie to maintain compatibility with earlier API versions. In some embodiments, the subscription identifier includes the NID of the SNPN preceded by the magic cookie. In some embodiments, the magic cookie is ““x3Lf57A””. In some embodiments, the subscription identifier is generated in the following format:
<MCC>><MNC>+““−””+<magic_cookie>+””id=<NID>:””+<OriginalSubscriptionID>. In some embodiments, the NF service consumer in the visited PLMN uses the subscription identifier to modify or terminate the subscription. In some embodiments, the local NRF in the visited PLMN does not maintain a state for each created subscription in different home PLMNs. In some embodiments, the local NRF routes the subscription request towards the SNPN NRF based on the MCC, the MNC and the NID. In some embodiments, the first network node is a local Network Repository Function in a visited Public Land Mobile Network, the second network node is a home Network Repository Function in a Home Public Land Mobile Network, and the network function consumer is a Network Function service consumer in the visited Public Land Mobile Network.

A further aspect of the invention relates to a method performed by a second network node for managing inter-PLMN subscriptions towards a Network Repository Function of a Standalone Non-Public Network in a communications network. The method comprises receiving at a second network node from a first network node a subscription request; creating at the second network node a subscription identifier that includes a Mobile Country Code (MCC), a Mobile Network Code (MNC), and a Network Identifier (NID) of the Standalone Non-Public Network, SNPN; and transmitting from the second network node to the first network node the subscription identifier. In some embodiments, the subscription identifier is generated in the following format:
<MCC>+<MNC>+““−” “+” “:nid=<NID>:””+<OriginalSubscriptionID>. In some embodiments, the subscription identifier further includes a magic cookie to maintain compatibility with earlier API versions. In some embodiments, the subscription identifier includes the NID of the SNPN preceded by the magic cookie. In some embodiments, the magic cookie is ““x3Lf57A””. In some embodiments, the subscription identifier is generated in the following format:
<MCC>+<MNC>+““−””+<magic_cookie>+““:nid=<NID>:””+<OriginalSubscriptionID>. In some embodiments, the NF service consumer in the visited PLMN uses the subscription identifier to modify or terminate the subscription. In some embodiments, the local NRF in the visited PLMN does not maintain a state for each created subscription in different home PLMNs. In some embodiments, the local NRF routes the subscription request towards the SNPN NRF based on the MCC, the MNC and the NID. In some embodiments, the first network node is a local Network Repository Function in a visited Public Land Mobile Network, the second network node is a home Network Repository Function in a Home Public Land Mobile Network, and the network function consumer is a Network Function service consumer in the visited Public Land Mobile Network.

A further aspect of the invention relates to a method performed by a network function consumer for managing subscriptions towards a second network node of a Standalone Non-Public Network in a communications network, SNPN, the method performed by a network function consumer, the method comprising transmitting to a first network node a subscription request; receiving from the first network node a subscription identifier; wherein the subscription identifier includes a Mobile Country Code, MCC, a Mobile Network Code, MNC, and a Network Identifier, NID, of the SNPN. In some embodiments, the subscription identifier is generated in the following format:

$$< MCC > + < MNC > + - : nid = < NID > : + < OriginalSubscriptionID > .$$

In some embodiments, the subscription identifier further includes a magic cookie to maintain compatibility with earlier Application Programming Interface, API, versions. In some embodiments, the subscription identifier includes the NID of the SNPN preceded by the magic cookie. In some embodiments, the magic cookie is ““x3Lf57A””. In some embodiments, the subscription identifier is generated in the following format:

$$< MCC > + < MNC > + - + < magic\_cookie > + : nid = < NID > : + < OriginalSubscriptionID > .$$

In some embodiments, the network function consumer uses the subscription identifier to modify or terminate the subscription. In some embodiments, the first network node does not maintain a state for each created subscription in different home Public Land Mobile Networks, PLMNs. In some embodiments, the first network node is a local Network Repository Function in a visited Public Land Mobile Network, the second network node is a home Network Repository Function in a Home Public Land Mobile Network, and the network function consumer is a Network Function service consumer in the visited Public Land Mobile Network.

This disclosure also provides mobile network nodes, particularly a first network node (110, 500), a network function consumer (700), and a second network node (110, 600) configured to perform the respective methods as described herein. In some embodiments, the first network node is a local NRF in a visited Public Land Mobile Network (local NRF) 110. In some embodiments, the network function consumer is a Network Function service consumer in the visited PLMN (NFc). In some embodiments, the second network node is a home NRF in a Home Public Land Mobile Network (home NRF) 110.

This disclosure also provides the corresponding computer program and computer program products comprising code, for example in the form of a computer program, that when run on processing circuitry of the mobile network nodes causes the mobile network nodes to perform the disclosed methods.

The solution and the features comprised therein are further described in what follows.

The proposed solution provides an improved method for managing inter-PLMN subscriptions towards a Network Repository Function (NRF) of a Standalone Non-Public Network (SNPN) in a communications network. The method enhances routing and communication between NRFs, Network Function (NF) service consumers, and NF service producers, leading to a more efficient and reliable management of inter-PLMN subscriptions in SNPN scenarios.

The method involves receiving a subscription request at a local NRF in a visited Public Land Mobile Network (PLMN), transmitting the request to a home NRF in a Home PLMN, and creating a subscription identifier at the home NRF that includes the Mobile Country Code (MCC), Mobile Network Code (MNC), and Network Identifier (NID) of the SNPN. The subscription identifier is then transmitted to the local NRF in the visited PLMN and provided to the NF service consumer.

In addition, the invention includes a magic cookie in the subscription identifier for maintaining compatibility with earlier API versions. The NF service consumer can further interact with the subscription identifier to modify or terminate subscriptions, providing greater control and flexibility in managing their subscriptions.

By incorporating the SNPN-ID into the subscription identifier and eliminating the need for local NRFs to maintain state for each created subscription in different home PLMNs, the invention provides a scalable, manageable, and secure solution for managing inter-PLMN subscriptions in various non-public network configurations.

In order to add the NID value, and maintain the compatibility with earlier API versions, it is proposed to define a “magic cookie” to maintain backwards compatibility with earlier data formatting versions and define a structure to include the NID. Such as:

$$\begin{matrix}< MCC > + < MNC > + - + x 3 Lf 57 A + :nid=<NID>: + < OriginalSubscriptionID > \\ E . g . : \\ ( Magic cookie = x 3 Lf 57 A ) \\ MCC = 123 , MNC = 456 , NID = 023 f 245 ac 42 \\ OriginalSubscriptionID = subs 987654 \\ \{ subscriptionID \} = 123456 - x 3 L f 57 A : nid = 023 f 245 ac 42 : subs 987654\end{matrix}$$

The presence of the “magic cookie” prevents accidental collision with subscription ids generated by existing implementations.

The magic cookie is optional, i.e. the subscription identifier generated could skip it and simply base on the nid=(11-chars): subsId, for example:

$$\{ subscriptionID \} = 123456 - nid = 023 f 245 ac 42 : subs 987654$$

However, the usage of the magic cookie is preferred (e.g., “x3Lf57A”) since it is a strong mechanism, e.g., to ensure that an older NRF implementation would not pick the magic cookie value.

In SNPN scenarios, an NF Consumer in a visited PLMN may create a subscription on the home NRF (i.e., the NRF in the SNPN) to receive notifications about profile changes for sets of NF instances. This subscription is created via the local NRF in the visited PLMN. The home NRF creates a subscription ID that contains routing information (e.g., the identity of the SNPN) that is sent via the local NRF to the NF Consumer in the Visited PLMN. This allows the NF Consumer to further interact with such newly created subscription (e.g., to modify the subscription, or to terminate it), based on the Subscription ID, by sending HTTP requests to the resource: . . . /subscriptions/{subscriptionID}.

Having the routing information inside the subscription ID allows that the local NRF (the NRF in the visited PLMN) to not maintain state for each created subscription in the different home PLMNs, which would be unmanageable.

Hereinafter, drawings showing examples of embodiments of the solution are described in detail.

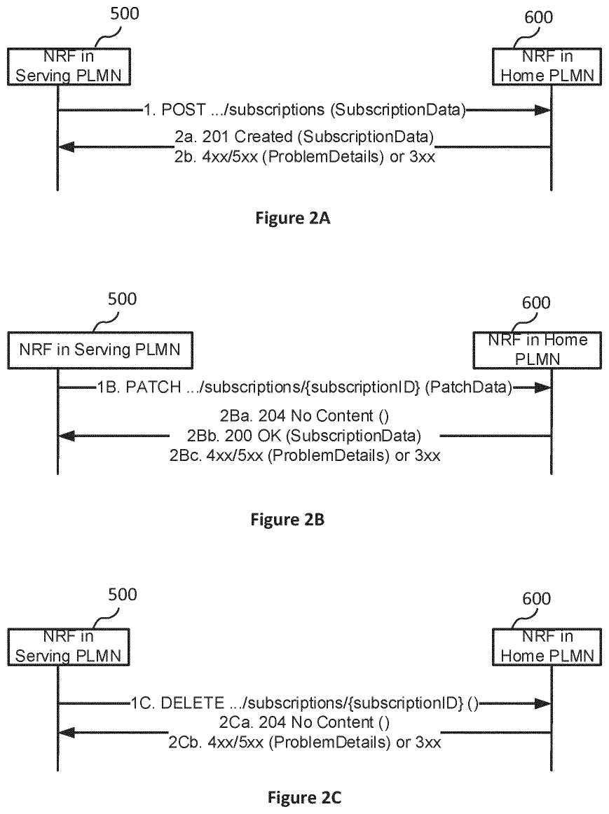

FIG. 2A is a signaling diagram illustrating a procedure for subscription to NF instances in a different PLMN. The procedure is performed by a first network node (110, 500) and a second network node (110, 600). In some embodiments, the first network node is a local Network Repository Function in a visited Public Land Mobile Network, and the second network node is a home Network Repository Function in a Home Public Land Mobile Network. The Serving PLMN is the PLMN that provides service to the User Equipment. In some embodiments, the visited Public Land Mobile Network is the Serving PLMN. In some embodiments, the home Public Land Mobile Network is the Serving PLMN.

The steps are executed between the NRF in the Serving PLMN and the NRF in the Home PLMN. The PLMN ID may be present in the SubscriptionData parameter. The NRF in the Home PLMN returns a subscriptionID identifying the created subscription. A new subscriptionID may be generated by the NRF in the Serving PLMN or Home PLMN and may be sent to the NF Service Consumer in the Serving PLMN or to the NRF in the Serving PLMN.

In step 1, the NRF in Serving PLMN sends a POST request to the resource URI in the NRF in Home PLMN representing the “subscriptions” collection resource. The request body includes the SubscriptionData as received by the NRF in Serving PLMN from the NF Service Consumer in the Serving PLMN, containing the data about the type of notifications that the NF Service Consumer is interested in receiving and the callback URI where the NF Service Consumer is prepared to receive the notifications from the NRF.

When step 1 is executed for an update (sending a PATCH request to the NRF, see FIG. 2B); the request includes the identity of the PLMN or SNPN of the NRF (MCC/MNC/NID values) as a leading prefix or component values of the susbcriptionID.

Similarly, when a delete step is executed (sending a DELETE request to the NRF, see FIG. 2C); this request includes the identity of the PLMN or SNPN of the NRF (MCC/MNC/NID values) as a leading prefix or component values of the subscriptionID.

In step 2a, on success, “201 Created” is returned. If the subscription is created in a different NRF in the home PLMN than the NRF in the home PLMN that receives the subscription request, the latter should include information in the subscriptionID (after the first 5 or 6 digits and “−”) such as to be able to forward the subsequent subscription modification or deletion request it may receive from the NRF in the serving PLMN towards the NRF in the home PLMN holding the subscription. The information to be included in the subscriptionID is left to implementation.

The NRF in Serving PLMN should not keep state for this created subscription and sends to the NF Service Consumer in Serving PLMN a subscriptionID that consists on the following structure:

If the Home NRF is located in a PLMN:

$$< MCC > + < MNC > + - + < OriginalSubscriptionID >$$

If the Home NRF is located in an SNPN:

$$< MCC > + < MNC > + - + x 3 Lf 54 A + :nid= + < NID > + : + < OriginalSubscriptionID >$$

The fixed 7-character string “x3Lf57A” is used to prevent accidental collisions with subscription IDs generated according to earlier versions of this specification, where the subscription ID could only contain MCC and MNC values; this mechanism is commonly known as “magic cookie”.

EXAMPLE 1: If the NRF in a Home PLMN (where MCC=123, and MNC=456) creates a subscription with value “subs987654”, the subscriptionID that the NRF in Serving PLMN would send to the NF Service Consumer in Serving PLMN is:

$$123456-subs 987654$$

EXAMPLE 2: If the NRF in an SNPN (where MCC=321, MNC=654 and NID=023f245ac42) creates a subscription with value “subs987654”, the subscriptionID that the NRF in Serving PLMN would send to the NF Service Consumer in Serving PLMN is:

$$321654-x 3 Lf 57 A:nid=023 f 245 ac 42:subs 987654 .$$

The URI in the Location header that the NRF in Serving PLMN returns to the NF Service Consumer in Serving PLMN contains a <subscriptionId> modified as described above and, if it is as an absolute URI, an apiRoot pointing to the address of the NRF in Serving PLMN. The subscriptionId attribute in the message body that the NRF in Serving PLMN returns to the NF Service Consumer in Serving PLMN also contains a <subscriptionId> modified as described above.

Step 2b takes place on failure or redirection. If the creation of the subscription fails at the NRF due to errors in the SubscriptionData JSON object in the request body, the NRF returns “400 Bad Request” status code with the ProblemDetails IE providing details of the error. If the creation of the subscription fails at the NRF due to NRF internal errors, the NRF returns “500 Internal Server Error” status code with the ProblemDetails IE providing details of the error. In the case of redirection, the NRF returns 3xx status code, which contains a Location header with an URI pointing to the endpoint of another NRF service instance.

FIG. 2B is a signaling diagram illustrating a procedure for update of subscription to NF instances in a different PLMN. The procedure is performed by a first network node (110, 500) and a second network node (110, 600). In some embodiments, the first network node is a local Network Repository Function in a visited Public Land Mobile Network, and the second network node is a home Network Repository Function in a Home Public Land Mobile Network. The Serving PLMN is the PLMN that provides service to the User Equipment. In some embodiments, the visited Public Land Mobile Network is the Serving PLMN. In some embodiments, the home Public Land Mobile Network is the Serving PLMN.

The update of subscription in a different PLMN is done by updating a subscription resource identified by a “subscriptionID”.

In step 1B, a PATCH request is sent from the NRF in the Serving PLMN to the NRF in the home PLMN; this request includes the identity of the PLMN or SNPN of the NRF (MCC/MNC/NID values) as component values of the susbcriptionID.

Steps 1B-2B(a-c) are executed between the NRF in the Serving PLMN and the NRF in the Home PLMN. The subscriptionID sent to the NRF in the Home PLMN does not contain the identity of the PLMN (i.e., it is the same subscriptionID value as originally generated by the NRF in the Home PLMN). The NRF in the Home PLMN returns a status code with the result of the operation.

FIG. 2C is a signaling diagram illustrating a procedure for subscription removal to NF instances in a different PLMN. The procedure is performed by a first network node (110, 500) and a second network node (110, 600). In some embodiments, the first network node is a local Network Repository Function in a visited Public Land Mobile Network, and the second network node is a home Network Repository Function in a Home Public Land Mobile Network. The Serving PLMN is the PLMN that provides service to the User Equipment. In some embodiments, the visited Public Land Mobile Network is the Serving PLMN. In some embodiments, the home Public Land Mobile Network is the Serving PLMN.

The subscription removal in a different PLMN is done by deleting a resource identified by a “subscriptionID”, in the NRF of the Home PLMN.

In step 1C, a DELETE request is sent from the NRF in the Serving PLMN to the NRF in the home PLMN; this request includes the identity of the PLMN or SNPN of the NRF (MCC/MNC/NID values) as component values of the subscriptionID.

Steps 1C-2C(a-b) are executed between the NRF in the Serving PLMN and the NRF in the Home PLMN. The subscriptionID sent to the NRF in the Home PLMN does not contain the identity of the PLMN (i.e., it is the same subscriptionID value as originally generated by the NRF in the Home PLMN). The NRF in the Home PLMN returns a status code with the result of the operation.

Thus, this disclosure proposes a method for managing subscriptions towards a second network node of a Standalone Non-Public Network in a communications network, SNPN, the method comprising receiving (S-301) at a first network node (500) from a network function consumer a first subscription request; transmitting (S-302) from the first network node to the second network node a second subscription request; transmitting (S-402) from the second network node to the first network node a first subscription identifier; and transmitting (S-304) from the first network node to the network function consumer a second subscription identifier; wherein the first or second subscription identifier includes a Mobile Country Code, MCC, a Mobile Network Code, MNC, and a Network Identifier, NID, of the SNPN.

Hereinafter, flowcharts showing examples of embodiments of the solution are described in detail.

The embodiments correspond to methods performed by and involving a network function consumer (700), a first network node (110, 500) and a second network node (110, 600). In some embodiments, the first network node is a local Network Repository Function in a visited Public Land Mobile Network, and the second network node is a home Network Repository Function in a Home Public Land Mobile Network. In some embodiments, the network function consumer is a Network Function service consumer in the visited Public Land Mobile Network.

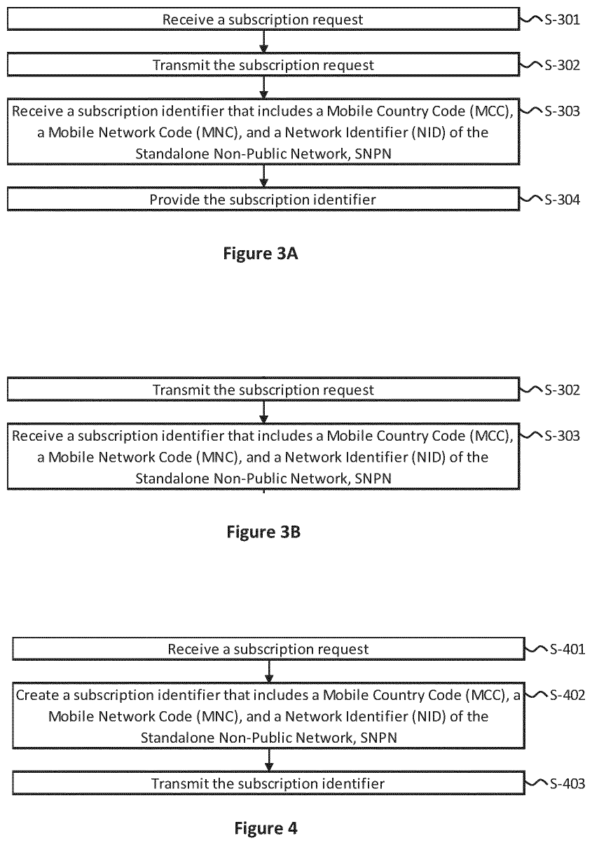

FIG. 3A is a flowchart illustrating a method performed by the first network node for managing inter-PLMN subscriptions towards a Network Repository Function of a Standalone Non-Public Network in a communications network.

In step S-301, the first network node receives from a network function consumer a subscription request.

In step S-302, the first network node transmits to a second network node the subscription request.

In step S-303, the first network node receives from the second network node a subscription identifier that includes a Mobile Country Code (MCC), a Mobile Network Code (MNC), and a Network Identifier (NID) of the Standalone Non-Public Network, SNPN.

In step S-304, the first network node provides to the network function consumer the subscription identifier.

In some embodiments, the subscription identifier is generated in the following format:

$$< MCC > + < MNC > + - + + : nid = < NID > : + < OriginalSubscriptionID > .$$

In some embodiments, the subscription identifier further includes a magic cookie to maintain compatibility with earlier API versions.

In some embodiments, the subscription identifier includes the NID of the SNPN preceded by the magic cookie.

In some embodiments, the magic cookie is ““x3Lf57A””.

In some embodiments, the subscription identifier is generated in the following format:

$$< MCC > + < MNC > + - + < magic\_cookie > + : nid = < NID > : + < OriginalSubscriptionID > .$$

In some embodiments, the NF service consumer in the visited PLMN uses the subscription identifier to modify or terminate the subscription.

In some embodiments, the local NRF in the visited PLMN does not maintain a state for each created subscription in different home PLMNs.

In some embodiments, the local NRF routes the subscription request towards the SNPN NRF based on the MCC, the MNC and the NID.

In some embodiments, the first network node is a local Network Repository Function in a visited Public Land Mobile Network, the second network node is a home Network Repository Function in a Home Public Land Mobile Network, and the network function consumer is a Network Function service consumer in the visited Public Land Mobile Network.

FIG. 3B is a flowchart illustrating a method performed by the network function consumer for managing inter-PLMN subscriptions towards a Network Repository Function of a Standalone Non-Public Network in a communications network.

In step S-302, the first network node transmits to a second network node the subscription request.

In step S-303, the first network node receives from the second network node a subscription identifier that includes a Mobile Country Code (MCC), a Mobile Network Code (MNC), and a Network Identifier (NID) of the Standalone Non-Public Network, SNPN.

In some embodiments, the subscription identifier is generated in the following format:

$$< MCC > + < MNC > + - + : nid = < NID > : + < OriginalSubscriptionID > .$$

In some embodiments, the subscription identifier further includes a magic cookie to maintain compatibility with earlier API versions.

In some embodiments, the subscription identifier includes the NID of the SNPN preceded by the magic cookie.

In some embodiments, the magic cookie is ““x3Lf57A””.

In some embodiments, the subscription identifier is generated in the following format:

$$< MCC > + < MNC > + - + < magic\_cookie > + : nid = < NID > : + < OriginalSubscriptionID > .$$

In some embodiments, the NF service consumer in the visited PLMN uses the subscription identifier to modify or terminate the subscription.

In some embodiments, the local NRF in the visited PLMN does not maintain a state for each created subscription in different home PLMNs.

In some embodiments, the local NRF routes the subscription request towards the SNPN NRF based on the MCC, the MNC and the NID.

In some embodiments, the first network node is a local Network Repository Function in a visited Public Land Mobile Network, the second network node is a home Network Repository Function in a Home Public Land Mobile Network, and the network function consumer is a Network Function service consumer in the visited Public Land Mobile Network.

FIG. 4 is a flowchart illustrating a method performed by the second network node for managing inter-PLMN subscriptions towards a Network Repository Function of a Standalone Non-Public Network in a communications network.

In step S-401, the second network node receives from a first network node a subscription request.

In step S-402, the second network node creates a subscription identifier that includes a Mobile Country Code (MCC), a Mobile Network Code (MNC), and a Network Identifier (NID) of the Standalone Non-Public Network, SNPN.

In step S-403, the second network node transmits to the first network node the subscription identifier.

In some embodiments, the subscription identifier is generated in the following format:

$$< MCC > + < MNC > + - + : nid = < NID > : + < OriginalSubscriptionID > .$$

In some embodiments, the subscription identifier further includes a magic cookie to maintain compatibility with earlier API versions.

In some embodiments, the subscription identifier includes the NID of the SNPN preceded by the magic cookie.

In some embodiments, the magic cookie is ““x3Lf57A””.

In some embodiments, the subscription identifier is generated in the following format:

$$< MCC > + < MNC > + - + < magic\_cookie > + : nid = < NID > : + < OriginalSubscriptionID > .$$

In some embodiments, the NF service consumer in the visited PLMN uses the subscription identifier to modify or terminate the subscription.

In some embodiments, the local NRF in the visited PLMN does not maintain a state for each created subscription in different home PLMNs.

In some embodiments, the local NRF routes the subscription request towards the SNPN NRF based on the MCC, the MNC and the NID.

In some embodiments, the first network node is a local Network Repository Function in a visited Public Land Mobile Network, and the second network node is a home Network Repository Function in a Home Public Land Mobile Network.

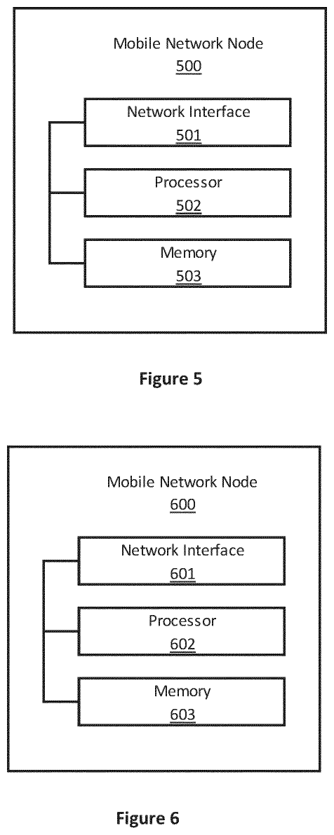

FIG. 5 is a block diagram illustrating elements of a mobile network node 500 of a mobile communications network. In some embodiments, the mobile network node 500 is a local NRF 110. As shown, the mobile network node may include network interface circuitry 501 (also referred to as a network interface) configured to provide communications with other nodes of the core network and/or the network. The mobile network node may also include a processing circuitry 502 (also referred to as a processor) coupled to the network interface circuitry, and memory circuitry 503 (also referred to as memory) coupled to the processing circuitry. The memory circuitry 503 may include computer readable program code that when executed by the processing circuitry 502 causes the processing circuitry to perform operations according to embodiments disclosed herein. According to other embodiments, processing circuitry 502 may be defined to include memory so that a separate memory circuitry is not required. As discussed herein, operations of the mobile network node may be performed by processing circuitry 502 and/or network interface circuitry 501. For example, processing circuitry 502 may control network interface circuitry 501 to transmit communications through network interface circuitry 501 to one or more other network nodes and/or to receive communications through network interface circuitry from one or more other network nodes. Moreover, modules may be stored in memory 503, and these modules may provide instructions so that when instructions of a module are executed by processing circuitry 502, processing circuitry 502 performs respective operations (e.g., operations discussed below with respect to Example Embodiments relating to core network nodes).

FIG. 6 is a block diagram illustrating elements of a mobile network node 600 of a mobile communications network. In some embodiments, the mobile network node 600 is a home NRF 110. As shown, the mobile network node may include network interface circuitry 601 (also referred to as a network interface) configured to provide communications with other nodes of the core network and/or the network. The mobile network node may also include a processing circuitry 602 (also referred to as a processor) coupled to the network interface circuitry, and memory circuitry 603 (also referred to as memory) coupled to the processing circuitry. The memory circuitry 603 may include computer readable program code that when executed by the processing circuitry 602 causes the processing circuitry to perform operations according to embodiments disclosed herein. According to other embodiments, processing circuitry 602 may be defined to include memory so that a separate memory circuitry is not required. As discussed herein, operations of the mobile network node may be performed by processing circuitry 602 and/or network interface circuitry 601. For example, processing circuitry 602 may control network interface circuitry 601 to transmit communications through network interface circuitry 601 to one or more other network nodes and/or to receive communications through network interface circuitry from one or more other network nodes. Moreover, modules may be stored in memory 603, and these modules may provide instructions so that when instructions of a module are executed by processing circuitry 602, processing circuitry 602 performs respective operations (e.g., operations discussed below with respect to Example Embodiments relating to core network nodes).

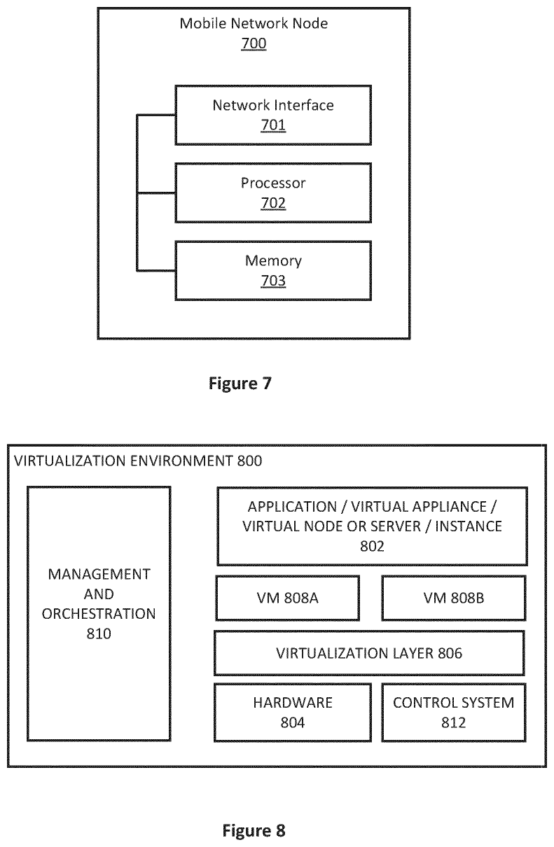

FIG. 7 is a block diagram illustrating elements of a mobile network node 700 of a mobile communications network. In some embodiments, the mobile network node 700 is a network function consumer. As shown, the mobile network node may include network interface circuitry 701 (also referred to as a network interface) configured to provide communications with other nodes of the core network and/or the network. The mobile network node may also include a processing circuitry 702 (also referred to as a processor) coupled to the network interface circuitry, and memory circuitry 703 (also referred to as memory) coupled to the processing circuitry. The memory circuitry 703 may include computer readable program code that when executed by the processing circuitry 702 causes the processing circuitry to perform operations according to embodiments disclosed herein. According to other embodiments, processing circuitry 702 may be defined to include memory so that a separate memory circuitry is not required. As discussed herein, operations of the mobile network node may be performed by processing circuitry 702 and/or network interface circuitry 701. For example, processing circuitry 702 may control network interface circuitry 701 to transmit communications through network interface circuitry 701 to one or more other network nodes and/or to receive communications through network interface circuitry from one or more other network nodes. Moreover, modules may be stored in memory 703, and these modules may provide instructions so that when instructions of a module are executed by processing circuitry 702, processing circuitry 702 performs respective operations (e.g., operations discussed below with respect to Example Embodiments relating to core network nodes).

FIG. 8 is a block diagram illustrating a virtualization environment 800 in which functions, network functions or network nodes implemented by some embodiments of the present disclosure may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 800 includes components defined by the O-RAN Alliance, such as an O-Cloud environment orchestrated by a Service Management and Orchestration Framework via an O-2 interface.

Applications 802 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 804 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 806 (also referred to as hypervisors or virtual machine monitors (VMMs)), provide VMs 808a and 808b (one or more of which may be generally referred to as VMs 808), and/or perform any of the functions, features and/or benefits described in relation with some embodiments described herein. The virtualization layer 806 may present a virtual operating platform that appears like networking hardware to the VMs 808.

The VMs 808 comprise virtual processing, virtual memory, virtual networking or interface and virtual storage, and may be run by a corresponding virtualization layer 806. Different embodiments of the instance of a virtual appliance 802 may be implemented on one or more of VMs 808, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 808 may be a software implementation of a physical machine that runs programs as if they were executing on a physical, non-virtualized machine. Each of the VMs 808, and that part of hardware 804 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 808 on top of the hardware 804 and corresponds to the application 802.

Hardware 804 may be implemented in a standalone network node with generic or specific components. Hardware 804 may implement some functions via virtualization. Alternatively, hardware 804 may be part of a larger cluster of hardware (e.g. such as in a data center or CPE) where many hardware nodes work together and are managed via management and orchestration 810, which, among others, oversees lifecycle management of applications 802. In some embodiments, hardware 804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 812 which may alternatively be used for communication between hardware nodes and radio units.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such tangible computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the tangible computer-readable media.

Computer-executable instructions include, for example, instructions and data which cause a general purpose computer, special purpose computer, or special purpose processing device to perform a certain function or group of functions. Computer-executable instructions also include program modules that are executed by computers in standalone or network environments. Generally, program modules include routines, programs, objects, components, and data structures that perform particular tasks or implement particular abstract data types. Computer executable instructions, associated data structures, and program modules represent examples of the program code means for executing steps of the methods disclosed herein. The particular sequence of such executable instructions or associated data structures represent examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Communication at various stages of the described system can be performed through a local area network, a token ring network, the Internet, a corporate intranet, 802.11 series wireless signals, fiber-optic network, radio or microwave transmission, etc. Although the underlying communication technology may change, the fundamental principles described herein are still applicable.

The various embodiments described above are provided by way of illustration only and should not be construed to limit the invention. For example, the principles herein may be applied to any remotely controlled device. Further, those of skill in the art will recognize that communication between the remote the remotely controlled device need not be limited to communication over a local area network but can include communication over infrared channels, Bluetooth or any other suitable communication interface. Those skilled in the art will readily recognize various modifications and changes that may be made to the present invention without following the example embodiments and applications illustrated and described herein, and without departing from the scope of the present disclosure.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and “comprising,” when used in this specification, specify the presence of stated features, integers, steps, operations, elements, or components, and combinations thereof, but do not preclude the presence or addition of one or more other features, integers, steps, operations, elements, or components, and combinations thereof. Further, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

1.-46. (canceled)

47. A method for managing subscriptions to a Standalone Non-Public Network (SNPN) in a communications network, the method performed by a first network node, the method comprising:
receiving a first subscription request from a network function consumer;
transmitting a second subscription request to a second network node;
receiving a subscription identifier from the second network node; and
transmitting the subscription identifier to the network function consumer,
wherein the subscription identifier includes a Mobile Country Code (MCC), a Mobile Network Code (MNC), and a Network Identifier (NID) of the SNPN.

48. The method of claim 47, wherein the subscription identifier has the following format:
$$< MCC > + < MNC > + - + : nid = < NID > : + < OriginalSubscriptionID > .$$

49. The method of claim 47, wherein the subscription identifier also includes a magic cookie that maintains compatibility with one or more previous versions of an Application Programming Interface (API).

50. The method of claim 47, wherein the subscription identifier includes the magic cookie followed by the NID of the SNPN.

51. The method of claim 47, wherein the magic cookie is “x3Lf57A”.

52. The method of claim 47, wherein the subscription identifier has the following format:
$$< MCC > + < MNC > + - + < magic\_cookie > + : nid = < NID > : + < OriginalSubscriptionID > .$$

53. The method of claim 47, wherein the subscription identifier facilitates modification or termination of the subscription by the network function consumer

54. The method of claim 47, wherein the first network node is a local Network Repository Function (NRF) in a Visited Public Land Mobile Network (PLMN), the second network node is a home NRF in a Home PLMN, and the network function consumer is a Network Function service consumer (NFc) in the Visited PLMN.

55. A method for managing subscriptions to a Standalone Non-Public Network in a communications network (SNPN), the method performed by a network function consumer, the method comprising:
transmitting a subscription request to a first network node; and
receiving a subscription identifier from the first network node,
wherein the subscription identifier includes a Mobile Country Code (MCC), a Mobile Network Code (MNC), and a Network Identifier (NID) of the SNPN.

56. The method of claim 55, wherein the subscription identifier has the following format:
$$< MCC > + < MNC > + - + : nid = < NID > : + < OriginalSubscriptionID > .$$

57. The method of claim 55, wherein the subscription identifier further includes a magic cookie to maintain compatibility with earlier Application Programming Interface, API, versions.

58. The method of claim 55, wherein the subscription identifier includes the magic cookie followed by the NID of the SNPN.

59. The method of claim 55, wherein the magic cookie is “x3Lf57A”.

60. The method of claim 55, wherein the subscription identifier has the following format:
$$< MCC > + < MNC > + - + < magic\_cookie > + : nid = < NID > : + < OriginalSubscriptionID > .$$

61. The method of claim 55, further comprising modifying or terminating the subscription using the subscription identifier.

62. The method of claim 55, wherein the first network node is a local Network Repository Function (NRF) in a Visited Public Land Mobile Network (PLMN), the second network node is a home NRF in a Home PLMN, and the network function consumer is a Network Function service consumer (NFc) in the Visited PLMN.

63. Apparatus configured to manage subscriptions to a Standalone Non-Public Network (SNPN) in a communications network, wherein:
the apparatus comprises a processor and a memory; and
the memory stores instructions that, when executed by the processor, cause the apparatus to perform the method of 47.

64. Apparatus configured to manage subscriptions to a Standalone Non-Public Network (SNPN) in a communications network, wherein:
the apparatus comprises a processor and a memory; and
the memory stores instructions that, when executed by the processor, cause the apparatus to perform the method of 55.
